(19) United States
(12) Patent Application Publication
(10) Pub. No.: US 2005/0089455 A1
(43) Pub. Date: Apr. 28, 2005

(54) Gas-using facility including portable dry scrubber system and/or over-pressure control arrangement

(76) Inventors: Paul J. Marganski, Seymour, CT (US); Joseph D. Sweeney, Brookfield, CT (US); Theodore A. Shreve, Watertown, CT (US); W. Karl Olander, Indian Shores, FL (US)

Correspondence Address: ATMI, INC., 7 COMMERCE DRIVE, DANBURY, CT, 06810, US

(21) Appl. No.: 10/693,413

(22) Filed: Oct. 24, 2003

(51) Int. Cl. F01N 3/00; B32B 27/02

(52) U.S. Cl. 422/168; 422/172

(57) ABSTRACT

A gas-using facility including a portable dry scrubber system and/or over-pressure control arrangement. The portable dry scrubber system is of a unitary modular form, accommodating transport and ready set-up, take-down, and redeployment in the process facility. The over-pressure control arrangement provides capability for release of over-pressure gas from a compressed gas storage vessel during an over-pressure event, e.g., overheating of a compressed gas cylinder during a semiconductor foundry fire, while avoiding the bulk release of the entire vessel contents that occurs when conventional pressure relief devices are employed.

### BACKGROUND OF THE INVENTION

1. Field of the Invention

This invention relates to a gas-using facility including a portable dry scrubber system and/or over-pressure control arrangement, such as is useful in semiconductor manufacturing operations.

2. Description of the Related Art

In various industries, including semiconductor manufacturing, it frequently is necessary to treat relatively small quantities of gas to remove contaminants and hazardous material therefrom prior to discharge of the gas stream to the atmosphere or to final treatment or other disposition. Gas streams requiring such treatment may be of widely varying type and frequently contain gaseous species that are highly toxic, flammable, corrosive and/or pyrophoric.

It is desirable to treat such low-volume gas streams in a safe, low-cost manner. In many industrial applications, gas treatment is carried out using scrubber systems. Such systems may be of a dry scrubber type, utilizing a bed of sorbent material having affinity for undesirable gaseous species, or of a wet scrubber type, utilizing water or other liquid medium for contacting the gas to remove the undesirable gaseous species.

In many instances, over-sized scrubber systems are employed for applications that may only require treatment of a relatively small quantity of gas. Scrubber systems typically are high-cost capital equipment items, which additionally require substantial time, effort and expense to install, and which in operation have high operating costs in respect of their utilities and maintenance requirements.

It therefore would be a significant advance in the art to provide a system that is well-matched to small-volume gas treatment operations, which eliminates or at least substantially reduces the cost and complexity attendant the use of conventional large-scale abatement systems.

In many instances, the gases that require abatement by effluent scrubbing is comprised in part of a feed gas that is supplied to the process facility, or it otherwise derives from a feed gas, e.g., as reaction products or by-products resulting from consumption or utilization of the feed gas in the process facility. Examples include gaseous organometallic reagents that are used in chemical vapor deposition, dopant-containing gas mixtures utilized in ion implantation operations, gases that are utilized as carrier fluids, e.g., hydrogen, helium, argon, etc., for active reagents, and inert gases that are utilized as diluents to ameliorate heat of reaction effects.

In such gas-using process facilities, the gas supplied to the facility may be delivered from compressed gas storage vessels, e.g., gas storage and dispensing cylinders, tube trailers, mini-bulk systems and fixed location storage tanks. Generally, such compressed gas storage vessels are equipped with pressure relief devices (e.g., see the Compressed Gas Association Handbook of Compressed Gases, 4th Edition, Kluwer Academic Publishers, Boston, 1999) in order to prevent over-pressurization and rupture of the storage vessel. Ruptures of compressed gas storage vessels caused by over-pressurization present significant health and safety issues, as well as serious regulatory and environmental issues, particularly where the compressed gas is of a hazardous or toxic character, as is the case with many of the gases used in semiconductor manufacturing and in many other industrial applications.

The possibility of catastrophic releases of compressed gas from ruptured compressed gas storage vessels generally requires that compressed gas storage vessels be placed at a substantial distance from the process facility, entailing the need for long piping runs and/or provision of physical barriers to accommodate health, safety and environmental concerns and regulations.

In addition, various protective measures are used in many gas-using facilities, to be activated when a compressed gas storage vessel is ruptured. These protective measures can be of numerous different types. Illustrative examples include deluge systems, large emergency release gas scrubbers, and/or containment buildings to house the gas storage vessels.

In some instances, the severe risks that are associated with bulk releases of compressed gas from ruptured gas storage vessels can dictate whether the process facility even uses bulk gas delivery systems at all, despite the fact that bulk delivery of gas is generally preferred as being more cost-effective than small-volume gas delivery or in-situ generation of the compressed gas for the process facility.

The compressed gas storage vessels used for bulk gas delivery to the process facility have a maximum use pressure, sometimes called the “rated working pressure,” as well as a rated burst pressure. The rated burst pressure is typically in a ratio of about 5:3 in relation to the rated working pressure. Actual fill pressure of the compressed gas storage vessel may be considerably less than the rated working pressure of the vessel.

In many applications, compressed gas storage vessels are equipped with pressure relief devices, which in the presence of an over-pressure condition in the vessel (i.e., a pressure greater than the rated working pressure, as for example a pressure approaching or exceeding the rated burst pressure) are operative to release the entire contents of the vessel to the surrounding environment of the vessel. A typical form of such pressure relief device is a rupture disk that is backed by a fusible metal plug. Pressure release devices are typically incorporated into the valve or the “bull plug” of the compressed gas storage vessel.

It would be a significant advance in the art to provide improved means for accommodating an over-pressure condition that avoids bulk release of gas to the environment of the compressed gas storage vessel.

### SUMMARY OF THE INVENTION

The present invention relates to a gas-using facility including a portable dry scrubber system and/or over-pressure control system, such as is useful in semiconductor manufacturing operations, as well as to the scrubber system and over-pressure control system per se.

In one aspect, the invention relates to a gas-using facility including a portable dry scrubber system and/or over-pressure control system for controllably venting over-pressure gas from a compressed gas storage vessel operatively connected in gas-supplying relationship to the gas-using facility and terminating venting when pressure in the compressed gas storage vessel has been reduced to a predetermined pressure below the burst pressure of the vessel.

In another aspect, the invention relates to a portable dry scrubber system comprising a unitary modular apparatus including a chamber having at least one bed of scrubbing material therein for contacting a gas containing at least one scrubbable component therein, to remove said at least one scrubbable component from the gas.

A further aspect of the invention relates to a over-pressure control system for controllably venting over-pressure gas from a compressed gas storage vessel operatively connected in gas-supplying relationship to a gas-using facility and terminating venting when pressure in the compressed gas storage vessel has been reduced to a predetermined pressure below the burst pressure of the vessel.

Yet another aspect of the invention relates to a gas supply system, comprising a gas storage and dispensing vessel, a pressure relief device operatively coupled with the gas storage and dispensing vessel and arranged for venting gas from the gas storage and dispensing vessel in response to over-pressure conditions in the vessel, a pressure relief line coupled with the pressure relief device for discharging gas permitted to vent from the gas storage and dispensing vessel by the pressure relief device, and a check valve in the pressure relief line to terminate flow of the venting gas at a predetermined pressure.

Other aspects, features and embodiments of the invention will be more fully apparent from the ensuing disclosure and appended claims.

### BRIEF DESCRIPTION OF THE DRAWINGS

FIG. 1 is a sectional elevation view of a portable dry scrubber system according to one embodiment of the present invention.

FIG. 2 is a schematic representation of a process facility including a compressed gas supply vessel, according to another embodiment of the invention.

### DETAILED DESCRIPTION OF THE INVENTION, AND PREFERRED EMBODIMENTS THEREOF

The disclosure of U.S. Pat. No. 6,494,343 issued Dec. 17, 2002 in the names of James V. McManus, et al. for “Fluid Storage and Dispensing System Featuring Ex-Situ Strain Gauge Pressure-Monitoring Assembly,” hereby is incorporated herein by reference in its entirety.

The present invention relates to a gas-using facility including a portable dry scrubber system and/or over-pressure control arrangement, such as is useful in semiconductor manufacturing operations.

The portable dry scrubber system of the invention is a unitary modular apparatus having utility for treatment of a gaseous effluent of a process facility, e.g., a semiconductor manufacturing plant. As opposed to fixed-position dry scrubber installations, which are typically overdesigned to accommodate all possible effluent stream variations of a process facility, the portable dry scrubber system of the present invention is a small-scale apparatus that is portable, being readily movable from place to place in the process facility, to accommodate a specific process tool or operation therein involving a small volume of gas treatment.

In this manner, the portable dry scrubber system is useful as a point-of-use scrubber unit for treatment of small volumes of gas, e.g., as produced in a process operation that is performed only irregularly in the process facility, at a specific tool or a specific location in the facility.

The process operation can for example be a specific wafer processing in a custom foundry for the manufacture of special purpose integrated circuitry, wherein the custom operation includes the one-time use or an infrequent use of a specific gaseous reagent that is flowed to a wafer reactor and produces an effluent composition, for which the portable scrubber unit includes a dry scrubber medium that is specific to such one-time or infrequent effluent. In this application, the portable scrubber unit is detachably coupled to the wafer reactor, to process the non-recurrent effluent, and at conclusion of the wafer processing operation, the portable scrubber unit is detached from the wafer reactor, and redeployed elsewhere in the custom chip foundry.

As another example, the portable dry scrubber unit can be removably attached to a gas cabinet, ion implant chamber containment structure, or other housing or enclosure within which gas leakage may occur, as a low-volume emergency release scrubber that is effective to treat gas leaking from broken lines, faulty valves and fittings, ruptured compressed gas cylinders, etc., and that can readily treat the small volumes of gas involved, and that can readily be changed out by uncoupling the portable scrubber unit from the associated gaseous effluent-generating equipment or installation.

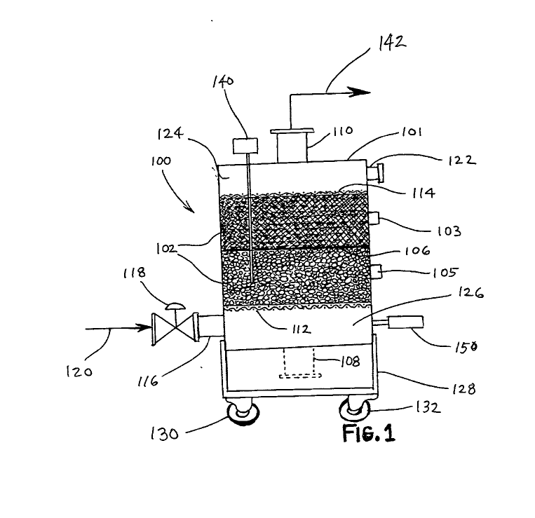

An illustrative portable dry scrubber system in accordance with the invention, in one embodiment thereof, is shown in FIG. 1.

As depicted in FIG. 1, the portable dry scrubber system 100 includes a chamber 101 containing one or more beds 102 of dry resin adsorbent or other scrubbing media. The chamber 101 may be separated into multiple treatment regions each containing a separate species of scrubbing medium. In the FIG. 1 embodiment, a screen, grid, mesh or other foraminous member 106 is disposed between the upper bed, and the lower bed, to separate the respective treatment regions from one another. Optionally, the upper bed may have a similar foraminous member 114 overlying its top surface, to retain the bed in position when the scrubber unit is transported to another use or storage location. The lower bed is disposed on a similar foraminous member 112, as a support element for the lower bed. Scrubbing media is introduced to the interior volume of the chamber thorough fill ports 103, and is removed from the chamber via such ports when the scrubbing media in the respective beds is exhausted.

By such arrangement, the chamber encloses an interior volume containing the scrubbing media bed(s), with a lower plenum space 126 below the (lower) bed, and headspace 124 overlying the (upper) bed.

The chamber 101 has an inlet port 116 to which is coupled the selectively actuatable gas feed valve 118, and which is coupled in turn to the feed gas line 120. Alternatively, the inlet port can be positioned at the bottom of the scrubber unit, as shown by the alternative inlet port 108 shown in dashed line representation in FIG. 1.

The chamber 101 has an outlet port 110 at its upper end for discharging treated gas to the gas discharge line 142.

In order that the dry scrubber system is portable in character, the chamber 101 has secured to a lower end portion thereof a supporting frame 128 equipped with wheels 130 and 132, as illustrated (another pair of corresponding wheels is positioned immediately behind the wheels 130 and 132, and not visible in the view shown). Each of the wheels may be equipped with a locking flange or lever that is selectively engageable to lock the wheels in position so that the scrubber system cannot roll or shift in position while it is being actively deployed for gas treatment.

The dry scrubber system may in lieu of the wheeled structure shown in FIG. 1 be equipped with casters, rollers, treads, bearings, low friction skeg elements or other means that render the dry scrubber unit motively translatable as a portable unit. The motive means of such dry scrubber system can additionally, or alternatively, include a motor, engine, battery, flywheel, driver, cabling or the like, by which the scrubber system can be portably moved from one location to another, for deployment or storage.

A variety of optional accessories can be utilized as part of the dry scrubber system, to monitor, control and/or enhance the efficacy of the treatment operation. Such accessories can for example include a pressure monitor 150 to monitor the pressure in the chamber 101, e.g., as part of an integrated instrumentation system for the scrubbing unit. The pressure monitor may include any suitable means, for example, pressure taps, pressure transducers, manometric taps, pressure gauges, etc. Another accessory that can usefully be employed in the scrubbing unit is a temperature monitor 140. The temperature monitor may be of any suitable type, as effective to detect temperature in the scrubbing media and produce a correlative output. The monitor may include thermocouples or thermistors, which provide a longitudinal temperature profile along the length of the bed (in the direction of gas flow therethrough), infrared thermal sensors or any other suitable devices and elements.

Another optional accessory of the scrubber system is an endpoint monitor 122, which may for example comprise a viewport containing a colorimetric element such as a paper or other porous web material impregnated with a chemistry that in exposure to one or more of the gaseous contaminants being abated, undergoes a color change, thereby indicating the breakthrough of the gaseous contaminant(s) and exhaustion of the scrubbing media intended to remove same from the gas being treated.

Other end-point sensors may be employed, such as electrochemical sensors, spectrometric sensors (e.g., infrared or ultraviolet radiation-based) detecting the breakthrough contaminant species, heat sensors detecting the enthalpy change of the scrubbing medium incident to sorptive uptake of the contaminant species (heat of sorption effects), or any other sensor, device or instrumental assembly that is effective for determining the existence of an end-point condition for the scrubbing media, by evidencing breakthrough or incipient breakthrough of contaminant species, thereby indicating that he scrubber media has been depleted of the capacity to remove such species.

Other optional accessories for the portable dry scrubber system include a motive fluid driver, for effecting flow of the gas through the scrubber chamber, from the inlet port to the outlet port thereof. The motive fluid driver can be of any suitable type, e.g., a pump, compressor, blower, fan, eductor, ejector, or the like, as dedicated to and associated with the scrubber chamber.

The scrubber chamber can be of any suitable shape and geometric form, e.g., cylindrical, cubic or rectangular. The height of the chamber may for example be in a range of from about 0.25 to 4 feet, with a diameter in a range of from about 0.1 to about 2 feet. The chamber may have a volume of scrubbing material therein that is in a range of from about 0.1 to about 10 gallons. In a preferred embodiment, the chamber has a volume in a range of from about 2 to about 3 gallons. The portable dry scrubber system, consistent with the foregoing, may have a footprint that is in a range of from about 0.01 to about 4 square feet, and may weigh from about 1 to about 200 pounds.

The scrubber may also be equipped with a dedicated central processing unit (CPU) for integrated control of the system, and the process condition monitoring accessories, as well as associated valving and flow control means, e.g., mass flow controllers, restricted flow orifices, etc.

Additionally, the bed may be equipped with an exchange means such as embedded cooling coils, heat exchange tubes, or the like, whereby the internally disposed heat exchanger serves to remove the heat of adsorption as contaminant species are sorptively removed by the scrubbing media in the chamber. Such internally disposed heat exchanger may be equipped with quick-disconnect couplings that are readily attached to and detached from supporting utilities such as cooling water or other heat transfer media.

In operation, gas to be treated enters the dry scrubber system through inlet port 116 from feed line 120, with valve 118 being open. The valve 118 can be of any suitable type, e.g., a throttle valve that is variable and selectively controllable to modulate the flow of influent gas to the scrubber system. The valve 118 can be a manual valve, or an automatic valve that is coupled with actuator or controller elements to control the setting of the valve and the flow rate of gas passed through it. The feed line 120 is suitably coupled to the valve 118, e.g., by a quick connect/disconnect coupling, so that the scrubbing system can be simply and easily connected to an upstream source of gas to be treated, e.g., a semiconductor manufacturing tool producing a gaseous effluent stream.

Gas entering the chamber 101 through the valve 118 and inlet port 116 flows into the lower plenum space 126 of the chamber and flows upwardly through the beds 102 for contacting with the scrubbing media therein. The chamber 101 is appropriately sized so that the superficial flow velocity of the gas through the bed(s) yields a contact time consistent with efficient removal of the undesired species from the gas, without the occurrence of bypassing, short-circuiting or other anomalous flow behavior in the bed(s).

The treated gas contacted with the scrubbing media then exits the upper bed and flows into the headspace 124, from which it is discharged from the bed in outlet port 110. From the outlet port 110, the treated gas, depleted in undesired species, flows into the gas discharge line 142, for venting to the atmosphere, passage to downstream post-scrubbing treatment, or other disposition.

During the flow of gas through the scrubber system, pressure monitor 150 monitors the pressure of the chamber 101 and the temperature is monitored by temperature monitor 140.

With continued flow of gas through the scrubbing media beds 102 in the chamber 101, the gas contacts the scrubbing medium in each of the successive beds, to effect removal of the gaseous contaminant species and yield a treated effluent. As the scrubbing media in the beds becomes progressively increasingly loaded with the contaminant species, the active sorption front moves longitudinally through the respective beds, in the direction of gas flow, until breakthrough occurs.

The breakthrough then is detected by the end-point monitor 122, which may actuate a signal processing unit to output an alarm, e.g., an audible and/or visual alarm, to evidence the need for shut-down of the scrubber system and change-out of the scrubbing medium therein.

While the illustrative embodiment of FIG. 1 is shown as having two successive fixed beds located in contiguous manner to one another, it will be recognized that the invention can be readily practiced with a single fixed bed of a single scrubbing medium, e.g., a resin/adsorbent material, or alternatively a dispersed mixture of different resin/adsorbent materials. Further, more than two successive fixed beds may be employed in the dry scrubber chamber, each comprising a different scrubbing medium for removal of different contaminants from the gas being treated.

Scrubber media generally useful in the broad practice of the present invention include any suitable media having sorptive affinity for the contaminant(s) of interest in the gas being treated, which are effective to remove such contaminant(s) when contacted with the gas under the process conditions employed in the scrubbing chamber. The process conditions (temperature, pressure, flow rate, etc.) may be selected to maximize the rate and extent of contaminant removal. Illustrative scrubber media include, without limitation: hydride gas scrubber materials such as CuO, ZnO, KOH, CuCO₃, CuSO₄, MnO, Cu(OH)₂, AgO, CoO, NiO, and Na₂O; acid gas scrubber materials such as Ca(OH)₂, KOH, CuSO₄, LiOH, Fe₂O₃, CuCO₃, and Cu(OH)₂; and gas scrubbing materials S407, S427, 447D, S450, S451D, S510, S515, S520, S525, S526 and S540, commercially available from ATMI, Inc. (Danbury, Conn., USA).

The scrubber media may be provided in any suitable form for use in the fixed bed arrangement of the scrubber system, being typically in a finely divided form, such as granules, particles, pellets, flakes, sheets, molded geometric forms, such as spherical forms, cylindrical forms, ring forms, etc., or any other geometrically regular or irregular form. In addition to finely divided forms, which may be of any suitable size, e.g., having a dimension (diameter, length, thickness, etc.) that is in a range of from about 0.1 mm to about 5 cm or more, the scrubber media may alternatively be provided in a monolithic form, e.g., as blocks, bricks, or other bulk forms.

The scrubber medium in each bed may also include a dispersed heat transfer sink material, to serve as thermal ballast to equalize bed temperature (i.e., dispersing the heat of adsorption effects) and avoid localized hot spots, such as may adversely effect the processing of the gas being treated.

As an illustrative example of scrubber media useful in the portable dry scrubber system of the invention, a scrubber unit of the type shown in FIG. 1 may be deployed for treatment of effluent gases resulting from chemical vapor deposition, in which the effluent gas contains arsine, phosphine, silane, or germane as a gaseous species to be removed and the scrubber medium in the chamber for treatment of such gas may comprise CuO, CuCO₃, Cu(OH)₂, AgO, CoO, NiO, Na₂O, ZnO, CuSO₄, MnO, etc.

As another illustrative example, the effluent gas to be treated may derive from an ion implantation operation, containing a dopant species such as arsine, and the scrubber media employed in the scrubber unit for treatment of such gas may comprise scrubber materials such as those described in the preceding paragraph.

In general, the portable dry scrubber system of the invention may be of any suitable size, as necessary in a given gas treatment application, that is consistent with portability of the system. In general, the unit may be sized based on volumetric flow rate considerations and constraints of superficial velocity and hydrodynamic considerations, to handle gas flows in a range from about 0.1 to about 35 standard cubic feet per minute, more preferably from about 0.5 to about 15 standard cubic feet per minute, and most preferably from about 1 to about 10 standard cubic feet per minute.

In semiconductor manufacturing effluent treatment applications, the portable dry scrubber system may be sized for treatment of effluents having flow rates in a range of about 1 to about 10 standard cubic feet per minute. The unit in such application, as discussed hereinabove, may be equipped with means imparting to the scrubber system a motively translatable character, such as selectively lockable wheels, casters, tires, cabling, tow lines, or the like, to enable the unit to be readily transportable within the semiconductor manufacturing facility, and the various gas and utilities ports on the chamber may be equipped with quick-connect/disconnect couplings, as previously described, consistent with the portability of the system.

In one illustrative embodiment, as useful for the treatment of effluents deriving from semiconductor manufacturing operations, the portable dry scrubber system is provided in a form similar to that schematically shown in FIG. 1, having a chamber diameter of 8 inches, a chamber length (in the direction of gas flow through the unit) of 1 foot, and a scrubbing medium volume of 0.36 cubic feet (2-3 gallons), an inlet end plenum (free) volume of 0.14 cubic feet (1 gallon) and a head space volume above the top end surface of the scrubbing medium of 0.05 cubic feet (0.3 gallons).

While the invention has been described illustratively hereinabove with primary reference to treatment of effluent gases in semiconductor operations, it will be recognized that the utility of the scrubber system of the invention is not thus limited, and that the scrubber system is readily implemented for the treatment of gas in a wide variety of other process and industrial applications.

Such other usages of the scrubber system include, by way of example, chamber vent scrubbing, scrubbing of non-semiconductor gas effluents, emergency release scrubbing for small-volume gas-handling operations, laboratory-scale research and development applications involving hazardous gas species, gas storage cylinder pump-down scrubbing, cylinder coffin venting, purification treatment of breathing air for enclosed spaces, etc.

The portable dry scrubber system of the invention can be utilized in a process facility, such as a semiconductor manufacturing operation, in combination with a gas source for a gas-using process facility, as hereinafter described.

The gas-using process facility utilizes a gas source for the process. Such source may comprise a compressed gas storage vessel, from which gas is selectively dispensed to the process facility as required in the specific process being conducted therein. The compressed gas storage vessel may be of any suitable type, e.g., a bulk delivery tank, a tube trailer, compressed gas cylinders, or other containment structure or installation in which the compressed gas is stored in a vessel for dispensing to the process facility.

In accordance with a further aspect of the invention, the compressed gas storage vessel for the process facility is equipped with an over-pressure control assembly, as an alternative to conventional pressure relief devices such as rupture disks that are employed to respond to over-pressure conditions by releasing the entire contents of the compressed gas storage vessel to the ambient surroundings of the vessel. As discussed hereinabove in the Background of the Invention section hereof, such bulk release of the entire contents of the compressed gas storage vessel produces an immediate hazard since the compressed gas as a result of its superatmospheric pressure is rapidly and irreversibly dispersed into the environment of the vessel.

The invention overcomes such severe deficiency of the prior art compressed gas storage vessels, by equipping the vessel with an over-pressure safety system, which functions to restrain release of gas from the vessel to a small amount as necessary to vent down the vessel to a pressure that is below the rated burst pressure, as for example of pressure that does not exceed the rated working pressure of the vessel. Such small volume release of gas thus can be readily abated, e.g., by a portable dry scrubber device such as has been described hereinabove.

The over-pressure safety system of the invention is of any suitable type that is effective to restrain release to a level necessary to restore normal pressure conditions that do not exceed the rated working pressure of the vessel, and to terminate release of gas once such normal pressure condition is restored, so as to minimize the amount of released gas requiring abatement or other disposition.

One type of over-pressure safety system in accordance with the invention comprises a strain gauge sensor that is operatively secured to a wall of the compressed gas storage vessel, to monitor the pressure of the gas in the vessel, by sensing of the strain experienced by the vessel wall. The strain gauge sensor may be affixed to the vessel wall and arranged as described in U.S. Pat. No. 6,494,343 issued Dec. 17, 2002 in the names of James V. McManus, et al. for “Fluid Storage and Dispensing System Featuring Ex-Situ Strain Gauge Pressure-Monitoring Assembly,” the disclosure of which hereby is incorporated herein by reference in its entirety, but with the modification that the strain gauge sensor is operatively coupled to pressure relief means such as a valve, piping, surge vessels or holding tanks, etc., by means of which the gas is vented, in order to return the compressed gas storage vessel to normal pressure conditions.

The strain gauge in such aspect of the invention is employed as a means for monitoring, either exclusively or redundantly, the interior pressure of the compressed gas storage vessel. The strain gauge pressure monitor may for example be provided as a redundant pressure monitor, in relation to other pressure monitoring devices, such as pressure transducers, pressure gauges, and pressure switches, which are associated with the vessel itself and/or with the flow circuitry receiving dispensed gas from the compressed gas storage vessel. Such transducers, gauges or switches provide direct pressure measurement, while strain gauge monitor provides a redundant pressure monitoring capability that is non-invasive in character.

As an illustrative example of an over-pressure safety system arrangement in accordance with the invention, the compressed gas storage vessel can be installed in a conventional manner, with coupling thereof to a delivery manifold on an associated pad, as commonly is done to deploy gas storage vessels for gas-dispensing service in semiconductor manufacturing operations. In accordance with the invention, however, a strain gauge monitor is mounted on the tank to monitor the strain in the wall of the vessel, with the strain gauge monitor being operatively linked with a gas isolation manifold which in turn is coupled to an emergency scrubber, e.g., a portable gas scrubber system of the type previously described herein.

The strain gauge monitor is operatively coupled to the gas isolation manifold, to actuate valving in the manifold and divert over-pressure gas from the compressed gas storage vessel through the valved manifold to the emergency release scrubber, if the strain gauge sensor indicates an over-pressure condition of sufficient magnitude.

By way of a further specific example, a gas storage vessel may be provided having a rated burst pressure of nominally 4,000 psig (pounds per square inch gauge). At normal temperatures, the gas storage vessel can contain the gas up to this pressure level. Should the strain gauge sensor detect a pressure rise in the gas storage vessel to a threshold pressure condition, such as may be encountered if a fire breaks out in the semiconductor manufacturing facility and subjects the gas storage vessel to elevated temperature conditions, the over-pressure gas in the vessel can be vented through the valved isolation manifold (whose valves are actuated for such purpose by a signal from the strain gauge sensor) to an emergency release system unit at a rate that will maintain the pressure of the compressed gas in the vessel below the burst pressure of the vessel, e.g., a pressure at or below 3500 psig.

The over-pressure safety system of the invention thereby provides a significant improvement over conventional use of pressure relief devices that employ rupture disks or similar failure elements, since the actuation of such conventional pressure relief devices results in the entire gas contents of the vessel being released to the ambient environment of the vessel. The invention remedies such deficiency by utilizing controlled release elements that release only the amount of the gas necessary to reduce the pressure to a predetermined safe level.

The amount of gas that must be treated due to a release event in a system according to the present invention therefore is substantially lower than the amount of gas that would need to be treated if a burst disk were ruptured resulting in bulk release. Accordingly, the amount of gas released in the event is minimized, and the over-pressure is vented to avoid dangerous pressure build-up in the vessel.

The released gas is suitably vented down within a piping system, e.g., to surge vessels or collection tanks coupled to the piping, so that the collected over-pressure gas can be flowed to a suitable treatment installation for abatement of the released gas. The treatment installation can for example comprise a wet or dry scrubber unit, e.g., a dry scrubber unit of a type described hereinabove.

The compressed gas storage vessel can be of any suitable type, and can for example be mobile, in case of tube trailers or rail cars for transport of the compressed gas. Such vessels can be equipped with strain gauge sensors for internal vessel pressure monitoring purposes. The use of a strain gauge sensor on the compressed gas storage vessel in accordance with the present invention also has an advantage of providing a pressure monitoring capability during the transport, e.g., shipping, of the vessel. For example, during truck transport of compressed gas cylinders equipped with strain gauge sensors, the detection by sensors of an over-pressure condition can be relayed to the driver, so that appropriate action is taken by way of response.

The strain gauge sensor of the present invention may be utilized as a single sensor unit, or as an array of sensors, which may for example be deployed at different locations on the compressed gas storage vessel. Multiple sensors are particularly advantageous where different portions of the vessel experience different pressure effects, due to the presence of complex curvatures or geometric factors, different wall thicknesses, etc.

The strain gauge monitoring arrangement, when constituted by an array of multiple sensor devices, may be arranged to provide outputs from the constituent strain gauge devices that are integrated or otherwise utilized as multiple inputs for actuation of the pressure relieving response, e.g., valve opening for controlled release of gas to a level below the threshold pressure. For such purpose, the strain gauges may be coupled to a central processing unit such as a programmable general-purpose computer, microprocessor, or other computational module or signal-processing unit, to produce an output correlative to the inputs, so that release of gas is effected upon occurrence of over-pressure conditions requiring same.

As a further application of strain gauge sensors on compressed gas storage vessels in accordance with the invention, the strain gauge sensor can be utilized to monitor the gas filing operation of the compressed gas storage vessel, as an independent measure of internal pressure. Such approach is superior to the commonly used procedure of placing gas-filled cylinders on scales to establish their filled weight and (by subtraction of the tare weight of the vessel from the filled vessel weight) the weight of the fill gas, as a basis for estimating the internal pressure attributable to the weight of added gas, and using the pressure determined for a single cylinder as representative of the gas pressure in a group of filled compressed gas cylinders of the same type.

The invention also provides, in another aspect, a system for accommodating an unintended venting of contents of a compressed gas storage and dispensing vessel due to premature failure of a pressure relief device (PRD), e.g., a burst disk, caused by mechanical defect or corrosion. In such system, a check valve is employed as a pressure control device, and is located downstream of the PRD. The check valve prevents the contents of the compressed gas vessel from unnecessarily entering the environment of the vessel, and avoids a potentially large release of gas.

The activation pressure of the check valve can be set at a suitable pressure value, e.g., at ˜50% of the expected working pressure of the compressed gas storage and dispensing vessel. Thus, if the PRD fails prematurely, the compressed gas is still contained safely in the gas storage and dispensing vessel. In the event of a fire or other substantial over-pressure event, the check valve pressure control device will operate to minimize the amount of gas that is released to the ambient environment of the vessel.

In this approach, the check valve pressure control device would be physically connected to the vessel's PRD outlet using appropriate fittings and piping, so that the connection to the check valve pressure control device can be broken and reestablished when the compressed gas storage and dispensing vessel is changed out or otherwise replaced in the facility in which it is employed. Gas that is discharged through the check valve pressure control device can be directed to an appropriate fixed or mobile abatement system for proper treatment of the released gas. Whereas PRD devices require considerable effort to replace, the check valve pressure control device can be periodically tested and easily maintained and replaced if necessary.

As an illustrative example, the compressed gas storage and dispensing vessel may have a rated burst pressure of 5000 psig and the conventional burst disk assembly on the vessel can be constructed to fail at a pressure of 4000 psig or, when a fusible metal plug is employed, at a specified elevated temperature, such as 165° F., or alternatively at 212° F. By accessorizing such compressed gas storage and dispensing vessel with a check valve pressure control device downstream from the burst disk assembly, where the check valve pressure control device has a set point (activation) pressure of 2000 psig, only the volume of gas in excess of the 2000 psig activation pressure will be released to the environment and/or require emergency abatement.

After the burst disk associated with the compressed gas storage and dispensing vessel has ruptured, the check valve pressure control device will operate to keep a sizeable percentage of the stored gas inside the containment vessel well below its rated burst pressure. The activation pressure for the check valve pressure control device, the burst pressure of the burst disk PRD, and the location of an associated emergency release abatement system for treatment of released over-pressure gas, may vary in specific embodiments of the invention, according to the particular application of the gas supply vessel and its location.

The set point of the check valve pressure control device can be set sufficiently low so that the check valve pressure control device will not allow accidental releases but will also not keep gas in the vessel to the point that the vessel fails in a fire.

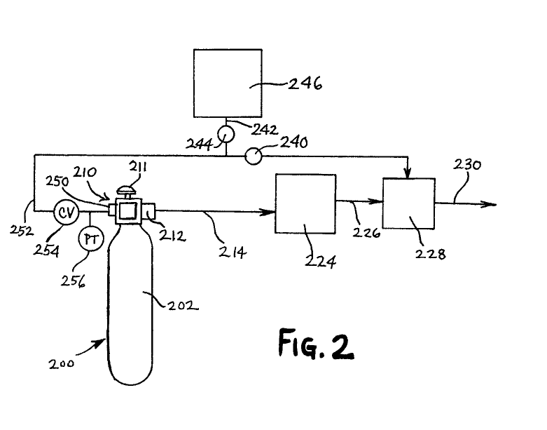

FIG. 2 is a schematic representation of a gas-using process facility including a compressed gas supply vessel 200, according to another embodiment of the invention.

The compressed gas supply vessel 200 has a wall 202 defining an enclosed interior volume for storage and dispensing of gas. The gas supply vessel 200 is provided with a valve head 210 including a hand wheel 211 for selectively manually opening or closing the valve element in the valve head. When the valve in the valve head is open during normal dispensing, the gas flows from the vessel into the discharge port 212 of the valve head, for discharge into feed line 214.

The feed line 214 is joined in gas feed relationship to the process facility 224, which may for example comprise a semiconductor manufacturing tool or manufacturing plant, wherein gas is used, e.g., in the implantation of dopant species into semiconductor wafers.

The process facility 224 uses the feed gas flowed to it in feed line 214 and produces an effluent, which may for example comprise unused feed gas, as well as product and/or byproduct gas species. The effluent is discharged from the process facility in effluent discharge line 226 and flowed to the effluent abatement system 228, which can for example comprise a wet scrubber, oxidation unit, dry scrubber, and/or other effluent treatment equipment, as necessary or desirable to remove the unwanted gaseous species from the effluent. The treated effluent then is discharged from the effluent abatement system 228 in discharge line 230, and may thereafter be vented to the atmosphere, or passed to other treatment, end-use, re-use, recovery or disposal facilities.

The compressed gas supply vessel 200 also is equipped with a pressure relief device 250 joined to the valve head 210 in communication with the gas in the vessel. The pressure relief device 250 can be of any suitable type, e.g., a burst disk, spring-biased pressure relief valve, fusible plug, etc. In a fire or thermal conditions producing severe over-pressure in the vessel, above the working pressure, e.g., approaching the rated burst pressure, the pressure relief device 250 at its operative pressure actuation level will be actuated to vent the contents of the vessel 202 into relief line 252. By way of specific example, the pressure relief device may comprise a burst disk arranged to fail at a vessel pressure of 3500 psig. Pressure relief devices also sometimes fail as a result of corrosion and/or mechanical defect, resulting in sudden and unanticipated blow-down of the vessel contents.

In accordance with one preferred aspect of the invention, a check valve 254 is disposed in the relief line 252, downstream of the pressure relief device 250, and arranged to limit the discharge of the gas from the vessel.

For example, in a fire, the pressure of gas in the gas supply vessel may rapidly increase beyond the maximum use pressure of the vessel, to a level approaching the rated burst pressure of the vessel. This will result in failure of the pressure relief device and venting of the gas contents of the vessel, but the check valve can be arranged to vent only the amount of the gas contents of the vessel that are necessary to reduce the pressure in the vessel from hazardous levels to non-hazardous levels. The check valve 254 can, for instance, be arranged with a set point that permits the hazardous over-pressure to be discharged downstream in the pressure relief line 252, so that pressure in the vessel is stabilized and maintained at a pressure below the maximum use pressure of the vessel.

In this manner, the majority of the gas can be retained in the vessel, at a safe pressure level, by appropriate selection of the set point of the check valve, so that only that amount of gas is released by the check valve to the downstream pressure relief line, which is necessary to ameliorate the hazardous over-pressure condition. For example, the pressure relief device may be actuated at a pressure of 3500-4000 psig, and the check valve may be arranged to permit flow of gas only at pressures exceeding 2500 psig, so that the vessel is able to retain 60-70% of its gas inventory while at the same time avoiding the occurrence of a rupture of the vessel in response to the over-pressure stimulus, e.g., a fire, malfunctioning heating jacket on the vessel, or other cause.

Further, the pressure relief device/check valve arrangement illustratively shown in FIG. 2 is effective to ameliorate the effects of corrosion and/or mechanical defects, which as mentioned above can result in sudden and unanticipated blow-down of the vessel contents.

As shown in FIG. 2, the gas vented from the vessel into pressure relief line 252 flows through the check valve 254 and may be flowed in such line, having flow control valve 240 therein, to the effluent abatement system 228 for treatment, recovery, or other disposition.

Alternatively, if the check valve is set at a set point so that only a small amount of over-pressure gas is flowed into the pressure relief line 252, then the released over-pressure gas may be flowed from the pressure relief line 252 into over-pressure vent line 242, containing flow control valve 244 therein, and passed to the portable dry scrubber system 246, which may be of a type as described in connection with FIG. 1 hereof. For this purpose, valve 244 in over-pressure vent line 242 would be open and the flow control valve 240 in pressure relief line 252 would be closed.

The overall arrangement shown in FIG. 2 therefore is able to utilize a portable dry scrubber system of the invention in a highly effective manner for point-of-use abatement of over-pressure gas in the event of an over-pressure circumstance producing a discharge through the pressure relief device associated with the gas supply vessel. Alternatively, the discharged over-pressure gas can be bypassed to the effluent abatement system of the overall process facility, as necessary or desirable in a given application of the invention.

The pressure relief line 252 in FIG. 2 also contains a pressure transducer 256 disposed in line 252 between the pressure relief device 250 and the check valve 254. The pressure transducer 256 can be operatively arranged to sense the over-pressure and to responsively actuate other components or operations in the facility. For example, the pressure transducer depending on the magnitude of the pressure may operate to generate a control signal that modulates flow control valve 244 and/or 240, or that increases the scrubbing action in portable dry scrubber 246 or abatement action in effluent abatement system 228, or that dynamically alters the set point of the check valve 254, to optimally respond to the over-pressure event and sudden release of over-pressure gas.

As an alternative to the arrangement shown in FIG. 2, the facility shown may be modified by deployment of a strain gauge on vessel 200, which is used to trigger venting of vessel contents during over-pressure conditions, wherein the pressure is below the actuation pressure of the pressure relief device 250, but above a desired maximum use pressure of the vessel. The strain gauge may be arranged for such purpose to actuate an over-pressure vent valve in a valved vent line (not shown in FIG. 2) coupled to feed line 214, wherein a flow control valve in such vent line is controlled in response to the pressure-correlated strain that is sensed by the strain gauge. The vent line thus constitutes a bypass line, and may in turn be coupled to portable dry scrubber 246 or to effluent abatement system 228, so that the vented over-pressure gas is subjected to abatement treatment.

It will be recognized that the process facility may comprise various of the aspects and features hereinabove described, in various embodiments of the invention, and that the portable dry scrubber unit provides a simple and efficient means of treating released over-pressure gas from a vessel during an over-pressure event. Alternatively, the portable dry scrubber system and the over-pressure control system may be utilized separately from one another, in various process applications.

While the invention has been described herein in reference to specific aspects, features and illustrative embodiments of the invention, it will be appreciated that the utility of the invention is not thus limited, but rather extends to and encompasses numerous other aspects, features and embodiments, as will readily suggest themselves to those of ordinary skill in the art, based on the disclosure herein. Accordingly, the claims hereafter set forth are intended to be correspondingly broadly construed, as including all such aspects, features and embodiments, within their spirit and scope.

1. A gas-using facility including a portable dry scrubber system and/or over-pressure control system for controllably venting over-pressure gas from a compressed gas storage vessel operatively connected in gas-supplying relationship to the gas-using facility and terminating venting when pressure in the compressed gas storage vessel has been reduced to a predetermined pressure below the burst pressure of the vessel.

2. The gas-using facility of claim 1, comprising a semiconductor manufacturing facility.

3. The gas-using facility of claim 1, including said portable dry scrubber system.

4. The gas-using facility of claim 3, wherein the portable dry scrubber system comprises a unitary modular apparatus including a chamber having at least one bed of scrubbing material therein for contacting with an effluent gas produced by the facility, to remove scrubbable components from the effluent gas.

5. The gas-using facility of claim 4, wherein the chamber comprises at least one inlet port and at least one discharge port for flow of gas therethrough, and said ports have associated therewith quick-connect/quick-disconnect couplings.

6. The gas-using facility of claim 4, wherein the chamber comprises process control means associated therewith.

7. The gas-using facility of claim 4, wherein the portable dry scrubber system comprises motive transport means for translation of the system.

8. The gas-using facility of claim 4, wherein the chamber has a volume of scrubbing material therein that is in a range of from about 0.1 to about 10 gallons.

9. The gas-using facility of claim 4, wherein the chamber has a vertically upstanding shape, and is arranged for vertical upward flow of gas therethrough.

10. The gas-using facility of claim 9, wherein the chamber is cylindrical, cubic or rectangular in form.

11. The gas-using facility of claim 4, wherein the chamber is sized to accommodate a flow therethrough of gas in a range of from about 0.1 to about 35 standard cubic feet per minute.

12. The gas-using facility of claim 4, wherein the scrubbing material comprises a sorbent material selected from the group consisting of CuO, CuCO₃, Cu(OH)₂, NiO, Na₂O, ZnO, Fe₂O₃, Ca(OH)₂, LiOH, KOH, MnO, CoO, AgO, and combinations of two or more of the foregoing.

13. The gas-using facility of claim 4, wherein the portable dry scrubber system has a footprint in a range of about 0.01 to about 4 square feet.

14. The gas-using facility of claim 4, wherein the portable dry scrubber comprises a viewport having a colorimetric indicator element therein to show a color change indicative of breakthrough of a contaminant gas species from the bed of scrubbing material.

15. A portable dry scrubber system comprising a unitary modular apparatus including a chamber having at least one bed of scrubbing material therein for contacting a gas containing at least one scrubbable component therein, to remove said at least one scrubbable component from the gas.

16. The portable dry scrubber system of claim 15, wherein the chamber comprises at least one inlet port and at least one discharge port for flow of gas therethrough, and said ports have associated therewith quick-connect/quick-disconnect couplings.

17. The portable dry scrubber system of claim 15, wherein the chamber comprises process control means associated therewith.

18. The portable dry scrubber system of claim 15, comprising motive transport means for translation of the system.

19. The portable dry scrubber system of claim 15, wherein the chamber has a volume of scrubbing material therein that is in a range of from about 0.1 to about 10 gallons.

20. The portable dry scrubber system of claim 15, wherein the chamber has a vertically upstanding shape, and is arranged for vertical upward flow of gas therethrough.

21. The portable dry scrubber system of claim 15, wherein the chamber is sized to accommodate a flow therethrough of gas in a range of from about 0.1 to about 35 standard cubic feet per minute.

22. The portable dry scrubber system of claim 15, wherein the scrubbing material comprises a sorbent material selected from the group consisting of CuO, CuCO₃, Cu(OH)₂, NiO, Na₂O, ZnO, Fe₂O₃, Ca(OH)₂, LiOH, KOH, MnO, CoO, AgO, and combinations of two or more of the foregoing.

23. The portable dry scrubber system of claim 15, having a footprint in a range of from about 0.01 to about 4 square feet.

24. The portable dry scrubber system of claim 15, comprising a viewport having a colorimetric indicator element therein to show a color change indicative of breakthrough of a contaminant gas species from the bed of scrubbing material.

25. An over-pressure control system for controllably venting over-pressure gas from a compressed gas storage vessel operatively connected in gas-supplying relationship to a gas-using facility and terminating venting when pressure in the compressed gas storage vessel has been reduced to a predetermined pressure below the burst pressure of the vessel.

26. The over-pressure control system of claim 25, wherein the vented over-pressure gas is flowed to an abatement system comprises a dry scrubber unit including a scrubbing material having sorptive affinity for the over-pressure gas.

27. The over-pressure control system of claim 25, comprising a failure element arranged to fail at a predetermined failure pressure.

28. The over-pressure control system of claim 25, wherein the failure element comprises a burst disk.
